(19) United States
(12) Patent Application Publication
(10) Pub. No.: US 2006/0080543 A1
(43) Pub. Date: Apr. 13, 2006

(54) METHOD OF CUSTOMIZING THE STARTUP LOGO OF A PROJECTOR

(76) Inventors: Chien-Wu Yen, Miao-Li County (TW); Tzu-Hai Chung, Miao-Li County (TW); Tung-Lung Lai, Miao-Li County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,861

(22) Filed: Oct. 11, 2004

(51) Int. Cl. H04L 9/00

(52) U.S. Cl. 713/183

(57) ABSTRACT

A method of customizing the startup logo of a projector. The main steps of the method include the following. First, a projector is connected to an external device. Thereafter, in batches, image data is read from an image file in the external device, stored in a memory buffer and written into a built-in flash memory of the projector to replace the startup logo with the image file. The method has the advantage of reaching the maximum resolution supported by the projector without any scaling operation or losing any quality. Moreover, the startup logo is fetched from an external device. Hence, its source is more comprehensive and can be changed at any time.

### BACKGROUND OF THE INVENTION

1. Field of the Invention

The present invention relates to a method for customizing the startup logo of a projector. More particularly, the present invention relates to a method of customizing the startup logo of a projector by replacing the original startup image with an image from an imported image file.

2. Description of the Related Art

The startup logo of a projector is normally standardized by the manufacturer. If the startup logo can somehow be customized, the projector will have additional value. However, changing the startup logo often involves modifying the firmware provided by the manufacturer. Hence, the manufacturer can only cater to the demands of a few special customers or companies.

At present, another method of customizing the startup logo is to capture a projected image. However, due to the limited storage capacity of the built-in memory inside a projector and its inability to capture image data in batches, only images with a resolution of 640×480 can be captured. To produce an image having a higher resolution such as 800×600 or 1024×786, an image scaling operation is required. Yet, image scaling can lead to distortion. Furthermore, using projected images as the startup logos restrict the images to a single source so that images from other sources are completely excluded.

In brief, a method of customizing the startup logo of a projector capable of increasing the resolution and quality of the images and providing comprehensive sources is in demand.

### SUMMARY OF THE INVENTION

Accordingly, at least one objective of the present invention is to provide a method of customizing the startup logo of a projector capable of reaching the maximum resolution supported by the projector without scaling or distortion. Furthermore, the startup logo can be read from an image file in an external device so that its source is more comprehensive.

To achieve these and other advantages and in accordance with the purpose of the invention, as embodied and broadly described herein, the invention provides a method of customizing the startup logo of a projector. The method mainly includes the following steps. First, a projector is connected to an external device. Thereafter, in batches, image data is read from an image file in the external device, stored in a memory buffer and written into a built-in flash memory of the projector to replace the startup logo with the image file.

In the aforementioned method of customizing the startup logo of a projector, the image file for replacing the original startup logo comes from an external device. Therefore, a broader spectrum of sources is available compared with a single source of capturing projected images of the conventional method. Furthermore, since the image file is transmitted in batches, the size of the memory buffer has no bearing on the size of the image file. In other words, the image file can reach the highest permissible resolution of the projector. Consequently, there is no need to scale the startup logo thereby eliminating the possibility of having a distorted image.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing the concept behind the method of customizing the startup logo of a projector according to one embodiment of the present invention.

FIG. 2 is a diagram showing a screen for inputting a password in the method of customizing the startup logo of a projector according to one embodiment of the present invention.

FIG. 3 is a flow chart showing the steps in the method of customizing the startup logo of a projector according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 1 is a block diagram showing the concept behind the method of customizing the startup logo of a projector according to one embodiment of the present invention. As shown in FIG. 1, the projector 101 has a built-in card reader 102 and a variety of transmission interface including, for example, universal serial bus (USB), RS232 and internal bi-directional communication (I2C) for reading image files from an external device to replace the original start-up logo of the projector. The external devices depicted in FIG. 1 include a mass storage device 103, a memory card 104 and a personal computer 106. The memory card 104 is connected to the projector 101 through the card reader 102. The image files inside the memory card 104 originate from a digital camera 105. In practice, the data within the memory card 104 may come from a variety of external devices that supports memory cards. And the types of external devices are not limited to those depicted in FIG. 1.

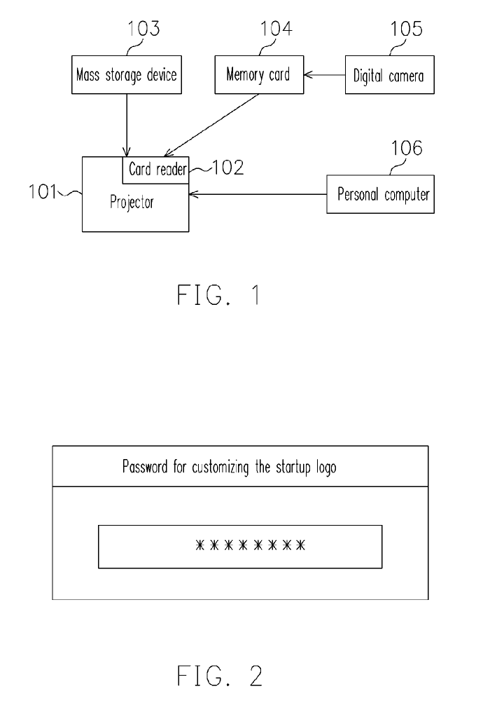

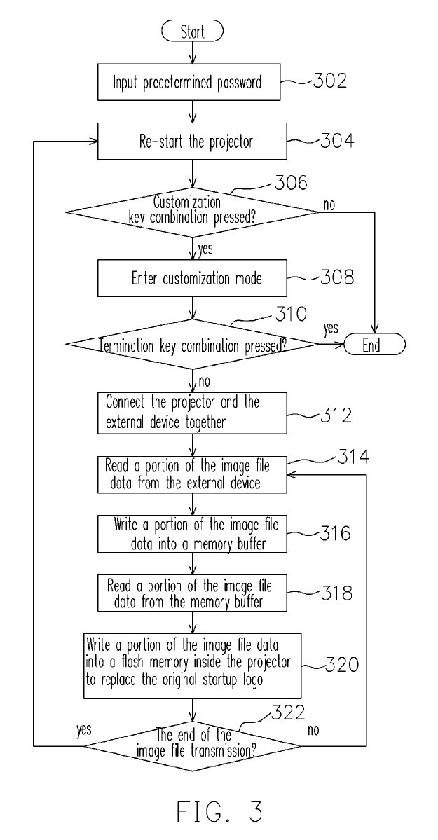

In the present embodiment, the user customizes the startup logo in the customization mode. To initiate the customization mode, a predetermined password is input into the on-screen display (OSD) of a projector so that the projector is scheduled to begin in the customization mode on the next startup operation. Thereafter, the projector is restarted to initiate the customization mode through a prescribed key combination. FIG. 2 is a diagram showing a screen for inputting the password in the method of customizing the startup logo of a projector according to one embodiment of the present invention. Obviously, the process of stepping into the customization mode can be adjusted or simplified according to actual need. For example, the step of inputting the password can be eliminated. FIG. 3 is a flow chart showing the steps of the method of customizing the startup logo of a projector according to one embodiment of the present invention.

As shown in FIG. 3, a user inputs the predetermined password in step 302. Thereafter, the projector is restarted in step 304. At this moment, the original startup logo is still displayed. After turning the projector on for a period of time, an inspection is carried out to check if the aforementioned key combination is pressed in step 306. If it is, the projector initiates the customization mode in step 308 while waiting for a connection with an external device. On the other hand, if the user has not pressed the key combination after a predetermined period of time, the projector automatically proceeds to carry out the normal startup procedure and the process flow of the present embodiment ends automatically.

After the projector has entered the customization mode, the user may choose to press a key combination in step 310 to terminate the process flow without changing the original startup logo of the projector. The key combinations in steps 306 and 310 can be identical or different.

If the user does not want to terminate the process flow, the projector and an external device for providing the image files are connected together in step 312. Thereafter, the projector will read image file data in batches to replace the original startup logo. In the present embodiment, the projector uses its built-in flash memory to store the startup logo. Furthermore, there is a memory buffer disposed between the external device and the flash memory for holding the image file data temporarily. Therefore, the projector 314 will read out a portion of the image file data in step 314 and write that portion of the image file data into the memory buffer in step 316. Then, a portion of the image file data is read from the memory buffer in step 318 and that portion of the image file data is written into the flash memory in step 320 to replace the original startup logo. After that, an inspection is made to determine if the transmission of the image file is complete or not. If the transmission remains incomplete, the operation branches back to step 314 so that the process of reading image file data is continued. The reason for the need to read image file data in batches is that the memory buffer has a limited memory storage capacity so that it may not be able to accommodate an entire image file. As long as the image file data is read in batches, the size of the image file that can be read is not limited by the size of the memory buffer and hence the image file can have the optimum resolution.

At the end of image file transmission, the process flow according to the present embodiment returns to step 304 and restarts the projector so that the new startup logo is displayed. Thereafter, the user may choose to terminate the process flow in step 306 or press the key combination to reenter the customization mode for changing the startup logo again.

The presence of the startup logo customization function not only increase the value of the projector, but can also put on company name and identification marks in the opening scene as a form of advertisement. In addition, ownership announcement can be added to the startup logo so that reselling a stolen projector is difficult.

In the method of customizing the startup logo of a projector according to the present invention, the image file for replacing the original startup logo comes from an external device. Therefore, a broader spectrum of sources is available compared with a single source of capturing projected images of the conventional method. Furthermore, since the image file is transmitted in batches, the size of the memory buffer region has no bearing on the size of the image file. In other words, the image file can reach the highest permissible resolution for the particular projector. Consequently, there is no need to scale the startup logo thereby eliminating the possibility of having a distorted image.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of customizing the startup logo of a projector, comprising the steps of:
connecting said projector to an external device; and
transmitting an image file from said external device into said projector to replace said startup logo of said projector.

2. The method of claim 1, wherein before connecting said protector to said external device, further comprises performing an initialization to enter into a customization mode.

3. The method of claim 2, wherein before entering said customization mode, further comprises inputting a predetermined password.

4. The method of claim 3, wherein said password is input through an on-screen display.

5. The method of claim 2, wherein before entering said customization mode, further comprises pressing a first key combination.

6. The method of claim 2, wherein after entering said customization mode but before connecting said projector with said external device, further comprises an optional step of pressing a second key combination to terminate the startup logo customization procedure so that said startup logo is not replaced.

7. The method of claim 1, wherein said projector stores said startup logo inside a built-in flash memory.

8. The method of claim 7, wherein the step of transmitting said image file from said external device to said projector to replace said startup logo further comprises:
reading said image file from said external device;
writing said image file into a memory buffer;
reading said image file from said memory buffer; and
writing said image file into said flash memory.

9. The method of claim 8, wherein from the step of reading said image file from said external device to the step of writing said image file into said flash memory proceed in a batch format, and the amount of image file data in each batch is accommodated by said memory buffer.

10. The method of claim 1, wherein said external device comprises a mass storage device.

11. The method of claim 1, wherein said external device comprises a personal computer.

12. The method of claim 1, wherein said external device comprises a memory card.

13. The method of claim 12, wherein said image file inside said memory card originates from a digital camera.

14. The method of claim 12, wherein said projector has a built-in card reader for reading said image file from said memory card.

15. The method of claim 1, wherein the transmission interface between said projector and said external device comprises a universal serial bus (USB) interface.

16. The method of claim 1, wherein the transmission interface between said projector and said external device comprises a RS232 interface.

17. The method of claim 1, wherein the transmission interface between said projector and said external device comprises an internal bi-directional communication (I2C) interface.
